(19) United States
(12) Patent Application Publication
(10) Pub. No.: US 2006/0161772 A1
(43) Pub. Date: Jul. 20, 2006

(54) Secure authenticated channel

(76) Inventors: Johan Cornelis Talstra, Eindhoven (NL); Antonius Adriaan Maria Staring, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/560,641

(22) PCT Filed: Jun. 11, 2004
(86) PCT No.: PCT/IB04/50888

§ 371 Date: Dec. 13, 2005

(30) Foreign Application Priority Data
Jun. 17, 2003 (EP) 03101764.3

(51) Int. Cl. H04L 9/00

(52) U.S. Cl. 713/168

(57) ABSTRACT

To prevent copying of content on interfaces, a secure authenticated channel (SAC) must be set up. This requires authentication between devices. The invention proposes an authentication protocol where a first device (e.g. a PC) authenticates itself to a second device (e.g. a peripheral device) using a challenge/response protocol and a second device authenticates itself using a zero knowledge protocol, where preferably a secret of the zero knowledge protocol is scrambled and cryptographically bound to the key-block.

Digital media have become popular carriers for various types of data information. Computer software and audio information, for instance, are widely available on optical compact disks (CDs) and recently also DVD has gained in distribution share. The CD and the DVD utilize a common standard for the digital recording of data, software, images, and audio. Additional media, such as recordable discs, solid-state memory, and the like, are making considerable gains in the software and data distribution market.

The substantially superior quality of the digital format as compared to the analog format renders the former substantially more prone to unauthorized copying and pirating, further a digital format is both easier and faster to copy. Copying of a digital data stream, whether compressed, uncompressed, encrypted or non-encrypted, typically does not lead to any appreciable loss of quality in the data. Digital copying thus is essentially unlimited in terms of multi-generation copying. Analog data with its signal to noise ratio loss with every sequential copy, on the other hand, is naturally limited in terms of multi-generation and mass copying.

The advent of the recent popularity in the digital format has also brought about a slew of copy protection and DRM systems and methods. These systems and methods use technologies such as encryption, watermarking and right descriptions (e.g. rules for accessing and copying data).

One way of protecting content in the form of digital data is to ensure that content will only be transferred between devices if
the receiving device has been authenticated as being a compliant device, and
the user of the content has the right to transfer (move and/or copy) that content to another device.
   If transfer of content is allowed, this will typically be performed in an encrypted way to make sure that the content cannot be captured illegally in a useful format from the transport channel, such as a bus between a CD-ROM drive and a personal computer (host).

Technology to perform device authentication and encrypted content transfer is available and is called a secure authenticated channel (SAC). In many cases, a SAC is set up using an Authentication and Key Exchange (AKE) protocol that is based on public key cryptography. Standards such as International Standard ISO/IEC 11770-3 and ISO/IEC 9796-2, and public key algorithms such as RSA and hash algorithms like SHA-1 are often used.

Public key cryptography requires substantial computation power. For a host such as a personal computer this usually is not a problem. However, for a peripheral device like a CD-ROM drive, a handheld computer or a mobile phone, resources are at a premium. In general, a device requires dedicated hardware to perform the private key operations of a public key system at an acceptable speed. On the other hand, public key operations may be performed without dedicated hardware. Private key operations of a public key cryptosystem are usually calculations of the form g^{x} mod N, where x, g and N are typically 1,024-bit numbers. Public key operations on the other hand are of the same form, but here x is restricted to a small value, typically 3 or 2¹⁶+1. This makes public key operations faster to execute than private key operations.

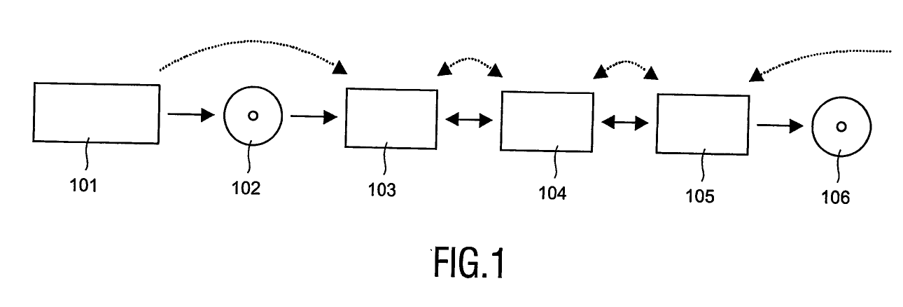

The SAC between host and device is only part of the chain by means of which publishers deliver content to end users. However, a system security analysis must consider the entire delivery chain. FIG. 1 shows an exemplary delivery chain that is considered in this document. From left to right, the delivery chain consists of a publisher 101, a (usually pre-pressed) optical disc 102, an optical disc player 103, a host 104, an optical disc recorder 105, and a second disc 106. This delivery chain takes into account that it may, under certain circumstances, be permitted to make a copy of a published disc. The communication channels between adjacent participants, indicated by the solid arrows, can be either uni-directional or bi-directional. The dotted arrows indicate how adjacent participants authenticate each other before content is passed on. Publisher 101 and player 102 use uni-directional broadcast encryption. Recorder 105 likewise. Player 103, host 104 and recorder 105 use a bi-directional SAC.

Throughout the entire delivery chain, content is transferred in an encrypted state. Trusted participants receive the decryption key along with the content. A participant is trusted if either the publisher or another trusted participant can authenticate that participant. Note that a trusted participant must authenticate its predecessor in the chain before it may use the encrypted content. In FIG. 1 for example, player and host as well as host and recorder use a SAC to securely transfer content. To establish the SAC they authenticate each other.

In general there are three types of authentication protocols which are not based on a universal secret:
1. challenge/response authentication, such as the Sapphire SAC establishment protocol, which are only supported by bi-directional communication channels,
2. Zero Knowledge Protocols, such as those by Fiat-Shamir, Guillou-Quisquater, and Schnorr, are also only supported on bi-directional channels, and
3. broadcast encryption, which works on both uni-directional and bi-directional channels.

In a broadcast encryption protocol, authentication is usually closely linked with transfer of the content decryption key. For this purpose, each participant has a unique set of cryptographic keys. Here, these keys are referred to as secret keys. Individual secret keys may be in included in the sets of many participants. The publisher creates a message that contains the content decryption key. This message is encrypted using the secret keys in such a way that only a subset of all participants can decrypt the content key. Participants that can decrypt the content key are implicitly authenticated. Participants that are not in the subset, and thus cannot decrypt the content key, are revoked.

E.g. for the uni-directional channel from the publisher to the player, one can use a broadcast encryption technology that is based on a hierarchical tree of cryptographic keys. The broadcast message is called the EKB. The decryption key contained in the EKB is called the Root Key. For more information, see
D. M. Wallner, E. J. Harder, and R. C. Agee, “Key Management for Multicast: Issues and Architectures,” Request For Comments 2627, June 1999.
C. K. Wong, M. Gouda, and S. Lam, “Secure Group Communications Using Key Graphs,” Proceedings SIG-COMM 1998, ACM Press, New York, pp. 68-79.

We will now discuss these 3 types of authentication and their advantages/disadvantages.

Public Key Protocol

The following notation will be adhered to in this document:
Pₓ [symbol] the public key belonging to X
Sₓ [symbol] the private key belonging to X
C=E[K,M] [symbol] ciphertext C is the result of encrypting message M with key K
M′=D[K C] [symbol] plaintext M is the result of decrypting C with key K.
Cert_{A}=Sign[S_{B},A] [symbol] Certificate Cert_{A} is the result of signing message A with private key S_{B}

Challenge/Response Based Public Key Protocol

In a Challenge/Response Public Key protocol, a user A (which can be a device) desires to authenticate him/herself to user B (which can also be a device). To that end A has received from a Licensing Authority (LA) the following:
a public-private key pair {P_{A}, S_{A}} (Of course the LA also selects a modulus which defines the finite field in which are calculations are done. For brevity we omit reference to this parameter. The public key P_{A} is really the tuple {P_{A}, N})
a certificate Cert_{A}=Sign[S_{LA}, A|P_{A}], where S_{LA} is the private key of the LA

All users (A and B) receive the public key of the licensing authority P_{LA}

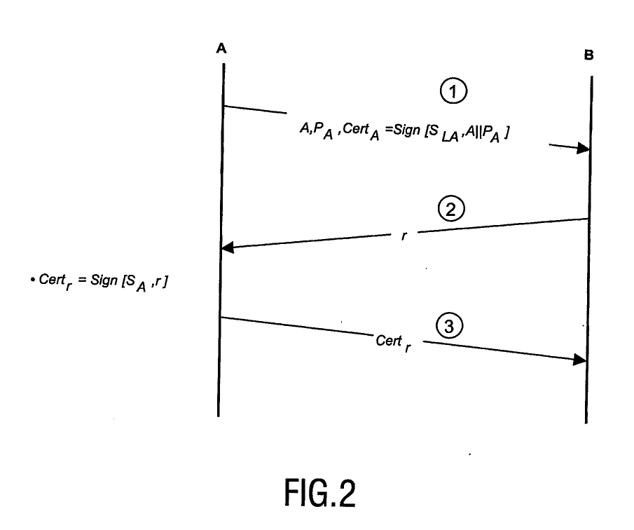

The protocol is outlined in FIG. 2. It works generally as follows:
1. A identifies himself to B by providing his identifier, here the serial number A, his public key P_{A}, and his certificate from the LA, to B.
2. B verifies the public key and identity of A from the certificate, using the public key of the LA, P_{LA}. If required, B checks that A and P_{A} aren't revoked: i.e. they appear on a whitelist or do not appear on a black-list. If true, B proceeds by generating a random number r, and sends it to A.
3. A responds by signing (encrypting) r with his private key S_{A} into a certificate Certᵣ and returns the result to B.
4. Using A's public key P_{A}, B verifies that the content of the certificate is identical to the number r he sent in step 2. If correct, A has proven that he has the secret key belonging to the public key P_{A}, i.e. he is A.

Step 1 can be postponed until step 3, so that only 2 passes are needed. To achieve mutual authentication, the protocol can be repeated with the entities performing the steps reversed. The steps can also be interchanged, e.g. first step 1 with A providing his identifier to B, then step 1 with B providing his identifier to A, and similarly for the other steps.

A variant of this protocol is one where B sends the random number r encrypted with A's public key. A then demonstrates knowledge of his secret key, by decrypting the received number r and returning it to B.

After authentication, a common key needs to be established, which can be done in a variety of ways. For example, A chooses a secret random number s and encrypts it with P_{B}, and forwards it to B. B can decrypt it with S_{B} to s, and both parties can use s as a common key.

It is clear that at the very least the protocol requires one private key operation from both parties, and perhaps 2 or more depending on the exact bus-key establishment protocol.

Zero Knowledge (Guillou-Quisquater) Based Public Key Protocol

In a Guillou-Quisquater (GQ) based Public Key protocol, a user A desires to authenticate him/herself to user B. To that end A has received from the Licensing Authority (LA) the following:
a public-private key-pair {J_{A}, S_{A}} (the LA also selects a public exponent v and a modulus N, which defines the finite field in which are calculations are done. For brevity we omit further reference to this parameter)
a certificate Cert_{A}=Sign[S_{LA}, A|J_{A}], where S_{LA} is the private key of the LA

All users (A and B) receive:
the public key of the licensing authority P_{LA}
v, the public exponent and security parameter. v is typically 2¹⁶ or 2²⁰.

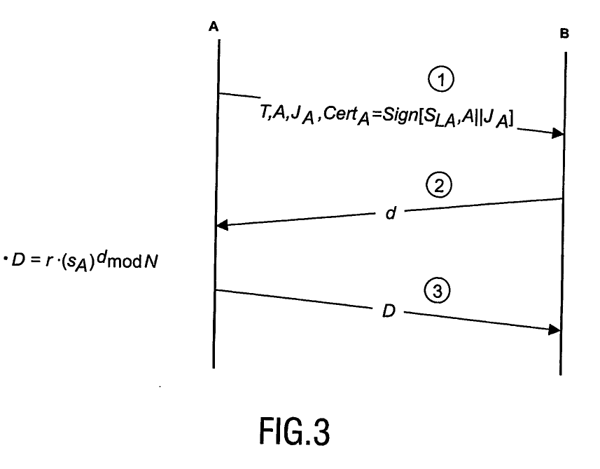

The protocol is outlined in FIG. 3. It works as follows.
1. A generates a random number r, r<N, and computes T=r^{v} mod N. A identifies himself to B by providing his identifier, here the serial number A, his public key J_{A}, his certificate from the LA and T.
2. B verifies the public key and identity of A from the certificate, using the public key of the LA, P_{LA}. If required, B checks that A and J_{A} are not revoked: i.e. they appear on a whitelist or alternatively do not appear on a blacklist. If true, B proceeds by generating a random number d from {1, . . . ,v-1}, and sends it to A.
3. A responds by constructing D=r·(s_{A})^{d} mod N, and returns the result to B.
4. Using A's public key J_{A}, B verifies that (J_{A})^{d}·(D)^{v}=T mod N. If correct, A has proven that he knows s_{A} with probability 1:v., i.e. with high likelihood he is A.

To achieve mutual authentication, the protocol can be repeated with the entities performing the steps reversed. The steps can also be interchanged, e.g. first step 1 with A providing his identifier to B, then step 1 with B providing his identifier to A, and similarly for the other steps. Variants of this protocol are the (Feige-)Fiat-Shamir and Schnorr zero-knowledge protocols.

This protocol is much cheaper than challenge-response cryptography, because the expensive exponentiations always involve a relatively small power (3 to 5 digits, instead of hundreds) comparable to a public key operation. Unlike a private key operation, no key can be shared based on this protocol, so A and B don't end up sharing a secret.

The Guillou-Quisquater protocol is described in more detail in U.S. Pat. No. 5,140,634 (attorney docket PHQ 087030).

Broadcast-Based Protocols

In a Broadcast based protocol, a user A again desires to authenticate him/herself to another user B. To that end the LA supplies user A with
a set of device keys {K_{Al}, . . . ,K_{An}}, which set is unique to A. and User B with
another set of device keys {K_{Bl}, . . . ,K_{Bn}}, which set is unique to B.

The LA distributes to both users a so called keyblock, known under various guises as “MKB” (CPRM/CPPM), “EKB” (Sapphire), “RKB” (BD-RE CPS), “KMB” (xCP). From this point on, we will refer to it as EKB. The EKB is e.g. distributed on optical media, or via the internet. It is constructed in such a way that the devices that have not been revoked can extract a root-key from this key-block, which will be the same for all these devices. Revoked devices will only obtain nonsense from using their (revoked) device keys.

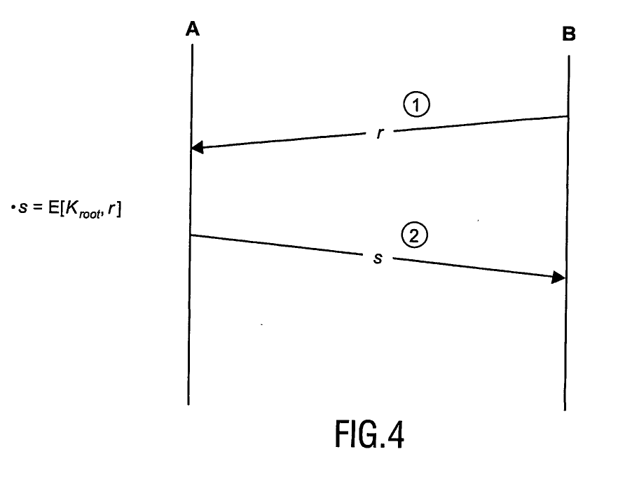

For an illustration of the protocol, refer to FIG. 4. It works as follows.
1. Both A and B compute the secret Kᵣₒₒₜ encoded in the EKB with their respective device keys. If they are not revoked, they will both obtain Kᵣₒₒₜ. B generates a random number r, and sends it to A.
2. A encrypts the received number with the secret extracted from the EKB and returns the result s to B
3. B decrypts s and verifies that the result is r.

To achieve mutual authentication, the protocol can be repeated with the entities performing the steps reversed. The steps can also be interchanged, e.g. first step 1 with A providing his identifier to B, then step 1 with B providing his identifier to A, and similarly for the other steps.

Note that B does not verify that A is who he claims, but only that A knows Kᵣₒₒₜ, i.e. A has not been revoked by the LA.

Broadcast Encryption based authentication is very cheap and fast because it requires only cost efficient symmetric cryptography. However, in the case where B is the PC-host software, the protocol is vulnerable to an insidious attack. Note that, contrary to the previous section, in order to check the integrity of A, the PC-software also needs to know Kᵣₒₒₜ. Now software is often hacked, and this means Kᵣₒₒₜ could be extracted from the software and published on a web-site, allowing a hacker to set up to authenticate successfully. Such software is hard to revoke, because no device keys are published in the attack.

After a few devices have been hacked and their device keys retrieved, hackers can start making their own (newer) EKBs thus turning once revoked devices back into non-revoked devices. To counter this, EKBs are often signed with the private key of the LA, so that tampering can be immediately detected.

It is an object of the invention to introduce a method of establishing a secure authenticated channel which avoids the disadvantages of public key authentication (high cost), EKB (leakage of Kᵣₒₒₜ in the host) and Zero Knowledge (no shared secret).

According to the invention, a first device (preferably a peripheral device) authenticates a second device (preferably a host computer) using a public key protocol. However, the second device authenticates the first device using a Zero-Knowledge protocol such as Guillou-Quisquater.

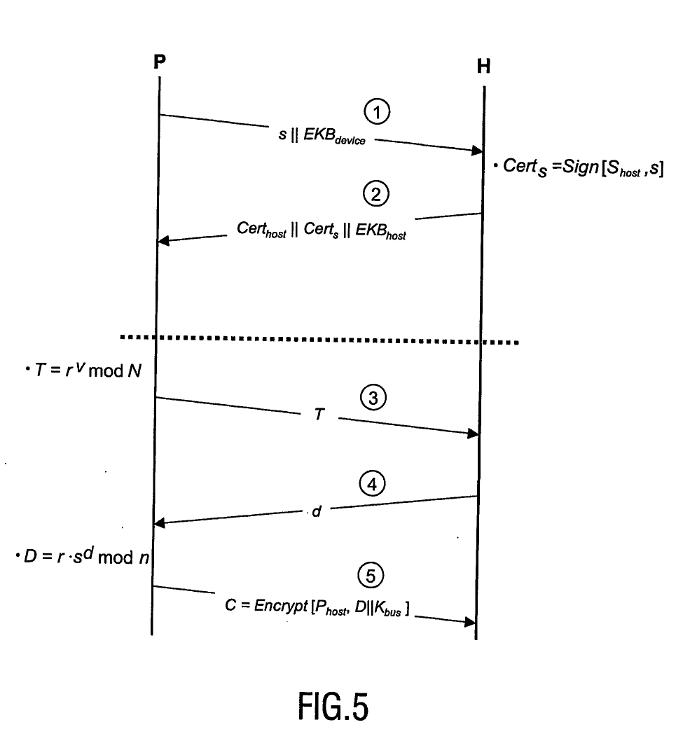

FIG. 5 schematically shows a preferred embodiment of the invention, by way of example showing authentication between a host computer H and a peripheral device P. An advantage of this embodiment is that the host computer does not require access to a set of secret keys. Instead, the host computer verifies that the peripheral device can decode the EKB (knowledge of Kᵣₒₒₜ) using the Guillou-Quisquater zero-knowledge protocol. Actually the peripheral device proves knowledge of Kᵣₒₒₜ because it can decrypt the GQ-private key which is stored encrypted with Kᵣₒₒₜ in the EKB. Consequently, the operations that the peripheral device has to perform according to this protocol require a computation power that is about equal to the public key operations of the Sapphire public key protocol.

The protocol according to this embodiment consists of five steps:
1. In the first step, the peripheral device sends the host computer a random number s as well as an EKB (EKB_{device}). The peripheral device obtains EKB_{device} from, e.g., an optical disc and claims that it can decode this EKB.
2. In the second step, the host computer sends the peripheral device its Certificate, Certₕₒₛₜ, a signed copy of s, and (optionally) an EKB (EKBₕₒₛₜ). The Certificate contains, a.o., the host's public key. The host computer uses its private key to generate the signed copy of s. The host computer may include EKBₕₒₛₜ if the host computer requires that the peripheral device be able to decode an EKB that was more recently issued than EKB_{device}. Upon receipt, the peripheral device verifies if the host's Certificate is acceptable. This means that the peripheral device verifies that the Certificate has been signed by a trusted authority. In addition, the peripheral device verifies that the Certificate has not been revoked (i.e. it does not appear on a Certificate Revocation List), or alternatively that the Certificate has been authorized explicitly (i.e. it appears on a Certificate Authorization List). If the Certificate is not acceptable, the peripheral device aborts the protocol. Otherwise the host computer has been authenticated.
3. In the third step, the peripheral device generates a random number r in the range 1 . . . N-1, and sends the host computer the value T=r^{v} mod n. Here v is the exponent, and N is the modulus of the public Guillou-Quisquater “public key” that is contained in either EKB_{device} or EKBₕₒₛₜ (whichever of the two is the most recently issued one).
4. In the fourth step, the host computer generates a random number d in the range 0 . . . v-1, and sends it to the drive.
5. In the fifth step, the peripheral device verifies the integrity of the EKB, computes Kᵣₒₒₜ with its device keys, and using Kᵣₒₒₜ it can decrypt the encrypted s (also in the EKB) 20 to obtain plain-text s. It then calculates the number D=r·s^{d} mod N, generates a bus key K_{bus}, and sends D|K_{bus} to the host computer, encrypted using the host's public key. Here s is the Guillou-Quisquater “private key” that is contained in the EKB. s is encrypted using the Root Key, which implies that only a peripheral device that can decode the EKB can access s). Prior to accepting the bus key, the host computer verifies that J^{d}·D^{v} mod N=T. Here J is part of the Guillou-Quisquater “public key” that is contained in the EKB. If the verification fails, the host computer aborts the protocol.

A property of this protocol is that the host computer is uniquely identified, but the peripheral device is not. That is, the host computer only knows that it is communicating with an authorized peripheral device, but it does not know which peripheral device it is communicating with.

Optionally, the efficiency of this protocol can be increased further by applying the teachings of British patent application serial number 0228760.5 (attorney docket PHNL021343) by P. Tuyls and B. Murray.

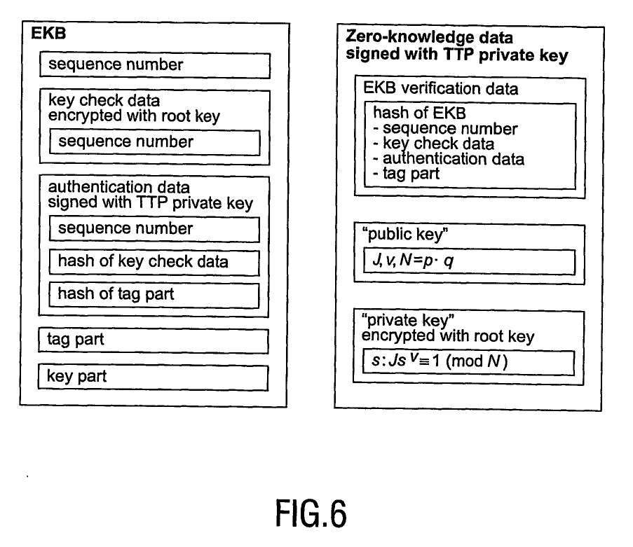

In order to best support the proposed protocol, either the EKB format has to be modified, or an additional data structure must be defined. FIG. 6 shows the first option, the EKB format in combination with a zero-knowledge data structure. Basically, the zero-knowledge data structure contains an EKB verification data field, which creates a link to the associated EKB. Note that this field replaces the functionality of the authentication data field in the EKB. The other two fields contain the Guillou-Quisquater “public” and “private keys.” The “private key” is encrypted using the Root Key of the EKB.

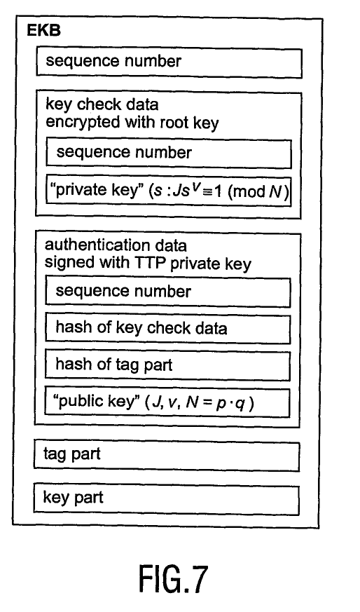

FIG. 7 shows the format of an enhanced EKB according to the second option. Here, the “public key” is added to the key check data field, which is encrypted using the Root Key. The “private key” is added to the authentication data field, which is signed by the TTP.

Of course the devices do not have to be personal computers and CD-ROM drives. Any device that is required to authenticate another device and/or to authenticate itself to that other device can benefit from the present invention. The content can be distributed on any medium or via any transport channel. For example, the content can be distributed on flash media or over a USB cable.

The device transmitting or receiving the content over the SAC may perform checks to see whether transmitting or receiving is permitted. For example, the content may have a watermark that indicates no copies may be made. In such a case transmission or reception should be blocked even if a SAC was successfully set up.

The devices could be part of a so-called authorized domain in which more liberal copying rules may apply. In authorized domains also SACs are commonly used to establish secure content transfer between the members of the domain. See for example International patent application WO 03/047204 (attorney docket PHNL010880) and International patent application WO 03/098931 (attorney docket PHNL020455).

It should be noted that the above-mentioned embodiments illustrate rather than limit the invention, and that those skilled in the art will be able to design many alternative embodiments without departing from the scope of the appended claims. The invention is preferably implemented using software running on the respective devices and arranged to execute the protocol according to the invention. To this end the devices may comprise a processor and a memory to store the software. Secure hardware for e.g. storing cryptographic keys is preferably used. A smart card can be provided with such a processor and a memory. The smart card can then be inserted into a device to enable the device to use the invention. Of course the invention can also be implemented using special circuitry, or a combination of dedicated circuitry and software.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer.

In the system claim enumerating several means, several of these means can be embodied by one and the same item of hardware. The mere fact that certain measures are recited in mutually different dependent claims does not indicate that a combination of these measures cannot be used to advantage.

1. A method of establishing a secure authenticated channel between two devices device A and device B, where A authenticates to B using challenge/response public key cryptography, and device B authenticates to device A using a zero-knowledge protocol.

2. The method of claim 1, in which the zero-knowledge protocol is a Guillou-Quisquater zero-knowledge protocol.

3. The method of claim 1, in which the zero-knowledge protocol is a Fiat-Shamir zero-knowledge protocol.

4. The method of claim 1, in which the zero-knowledge protocol is a Schnorr zero-knowledge protocol.

5. The method of claim 1, in which device B authenticates to device A using a combination of the zero-knowledge protocol and a broadcast-encryption system, where a secret used in the zero-knowledge protocol is scrambled such that it can only be obtained by those that can process a broadcast encryption key-block successfully.

6. The method of claim 5, where the secret used in the zero-knowledge protocol is encrypted by the root-key Kᵣₒₒₜ of a broadcast encryption system key-block.

7. The method of claim 5, where there is one key block with a root key K_{root,1} to allow for authentication, and another key block with root key K_{root,2} for content encryption.

8. The method of claim 1, where the zero-knowledge pair {J,s} is different for every key-block.

9. The method of claim 5, in which device B generates a bas key and sends the bas key to device A.

10. The method of claim 9, in which device A only accepts the bas key if device A can verify that device B can descramble the secret.

11. A system comprising a first device A and a second device B, where the device A is arranged to authenticate to the device B using challenge/response public key cryptography, and the device B is arranged to authenticate to the device A using a zero-knowledge protocol.

12. A first device A arranged to authenticate itself to a second device B using challenge/response public key cryptography, and arranged to authenticate the second device B using a zero-knowledge protocol.

13. A second device B arranged to authenticate itself to a first device A using a zero-knowledge protocol, and arranged to authenticate the first device A using challenge/response public key cryptography.

14. A computer program product comprising code enabling a programmable device to operate as the first device of claim 12.
